(19) United States
(12) Patent Application Publication
(10) Pub. No.: US 2026/0360281 A1
(43) Pub. Date: Nov. 12, 2026

(54) IMPROVEMENTS IN OR RELATING TO A MEDICAL SIMULATION SYSTEM

(71) Applicant: LIMBS & THINGS LIMITED, Bristol (GB)

(72) Inventors: Jonathan Jarman, Bristol (GB); Marcus Parker, Bristol (GB); James Myers, Bristol (GB)

(73) Assignee: LIMBS & THINGS LIMITED, Bristol (GB)

(21) Appl. No.: 19/111,866

(22) PCT Filed: Sep. 15, 2023
(86) PCT No.: PCT/GB2023/052396

§ 371 Date: Mar. 14, 2025

(30) Foreign Application Priority Data
Sep. 16, 2022 (GB) 2213614.7
Sep. 16, 2022 (GB) 2213617.0
Sep. 16, 2022 (GB) 2213619.6

(51) Int. Cl. G09B 23/32

(52) U.S. Cl. CPC G09B 23/32

(57) ABSTRACT

A medical simulation system comprising: a medical simulation unit having an RFID tag; and a separate module comprising an RFID reader, a transmitter and a memory for storing content, wherein the module is configured to output content from the memory via the transmitter when the RFID reader detects the RFID tag.

### FIELD OF THE INVENTION

The present invention relates to improvements in or relating to a medical simulation system and, more specifically, to a medical simulation system configured to provide a more realistic user experience.

### BACKGROUND TO THE INVENTION

Medical simulation units are frequently used to educate/train students and/or medical professionals in various medical fields. However, existing medical simulation units typically compromise reproductions of human mechanics, including heart thrills and other biomechanical movement. In addition, these systems sometimes simplify or misdeliver the subtleties in cardiovascular or respiratory waveforms.

Some medical simulation units are also known to emit sounds in order to provide a more realistic user experience. However, these sounds are typically delivered through a fixed speaker. More specifically, these medical simulation units are usually mannequins and the speakers are typically located within, or beneath a surface or skin of, the mannequin. A device, such as a stethoscope, is then required to receive the sound from the speaker. However, users can often misplace the device due to the speaker's fixed location. As a result, the user may either partially hear the sound being emitted or not hear anything at all. In addition, a sound emitted by the speaker can be distorted as it travels through the mannequin. This produces an unrealistic and/or negative learning experience. It may also lead to misdiagnosis. These challenges result in an unsuitable learning experience for the user.

It is against this background that the present invention has arisen.

### SUMMARY OF THE INVENTION

According to the present invention there is provided a medical simulation system comprising: a medical simulation unit having an RFID tag; and a separate module comprising an RFID reader, a transmitter and a memory for storing content, wherein the module is configured to output content from the memory via the transmitter when the RFID reader detects the RFID tag.

In the present invention, the transmitter is located within a module that is separate from the medical simulation unit. The module may be portable. The module may be moveable with respect to the medical simulation unit. The separate module enables the output to be transmitted more reliably and/or clearly than existing medical simulation systems. For example, some existing medical simulation units generate outputs in the form of a sound. In these units, the transmitter is often a speaker located within the medical simulation unit. However, locating the speaker within the medical simulation unit causes the sound to be distorted as it travels through the structure of the simulation unit. Locating the transmitter within a separate module removes this distortion, thus providing a clearer and more realistic output.

Moreover, the use of RFID (Radio-frequency identification) technology within the medical simulation system enables a variety of different outputs to be transmitted by a single transmitter. For example, a plurality of different RFID tags may each be associated with different content. Alternatively, or in addition, a single RFID tag may be modified such that it is associated with different content over time. The transmitter may output each different piece of content upon detection of the corresponding RFID tag.

The output may comprise at least one of a sound, sound file, image, image file, video and video file. The transmitter may output a sound wave, generate an image, and/or produce a video. The output may comprise data. The data may comprise information regarding a user's actions, such as which tag(s) was activated and at what time.

The content may be a single piece of content or a plurality of pieces of content. The memory may store a single piece of content or a plurality of pieces of content. The memory may be an SD card. The SD card may store the content semi-permanently. In this context, ‘semi-permanently’ means that the content is permanently stored until it is manually removed and/or replaced. Alternatively, the memory may be short-term memory or random-access memory (RAM).

The module may be configured to connect to a device for receiving the output. The device may receive the output. The device may be a medical device. For example, the device may be a stethoscope, blood pressure monitor (also called a sphygmomanometer) or an ultrasound probe. Alternatively, the device may be a speaker. The speaker may be configured to output a sound.

The module may connect to the device via a mechanical coupling. In other words, the module may be configured to attach to a device. Alternatively, or in addition, the module may connect to the device via a wired or ‘over-the-air’ (OTA) connection.

The device may be configured to detect a sound, display an image, and/or play a video. The sound, image, and/or video may be output from the module. In some embodiments, the medical simulation system comprises the device.

The medical simulation unit may comprise a mechanically moveable element. A mechanically moveable element may be used to create a closer to life training experience for a user. For example, the mechanically moveable element may be a plate. The plate may be a chest plate configured to simulate human breathing. The mechanically moveable element may comprise an additional moveable element located thereon. The additional moveable element may be another plate.

However, moveable elements and the motors and/or actuators thereof create background noise within the medical simulation unit, which may also be detected by a user. This is a particular issue in traditional simulation units where speakers for generating outputs in the form of sounds are located within close proximity to moveable elements. The background noise may distort the output intended to be heard by the user. Therefore, using RFID technology and locating the transmitter within a module that is separate from a medical simulation unit reduces the effects of this background noise by providing separation between the source of the background noise and the transmitter.

The mechanically moveable element may replicate at least one of respiratory movements, cardiovascular movements, a pulse and a thrill. As such, the mechanically moveable element may be an actuator. The actuator may be a thrill simulation actuator. The thrill simulation actuator may be a linear resonant actuator. Replicating at least one of the aforementioned functions within the medical simulation unit provides a more realistic experience for the user. When the medical simulation unit is a mannequin, or a part thereof, the thrill simulation actuator and at least one RFID tag may be located on an axis that passes through the location of a heart valve. Therefore, the thrill simulation actuator may be aligned with at least one RFID tag.

The system may further comprise a processor configured to synchronize the output to the movement of the mechanically moveable element. For example, the output may comprise an audio file configured to replicate the sound of breathing. The mechanically moveable element may replicate the expanding and contacting of a chest. Synchronizing the output with the movable element enables the sound of the breathing to be heard at the same time as the mechanical element simulates the inhaling or exhaling of breath, for example. Other examples, including but not limited to the sound and movement of a beating heart or pulse, or a thrill, can also be envisaged. This provides a more realistic training experience.

The processor may be located within the module. Alternatively, or in addition, the processor may be located within the medical simulation unit. More specifically, the medical simulation unit may comprise a unit processor and the module may comprise a module processor. In some embodiments, the medical simulation unit and/or module comprise a plurality of processors. Each processor may be a microprocessor. The medical simulation unit may further comprise a unit memory. Therefore, the system may comprise a module memory located within the module (previously referred to as ‘the memory’) and a unit memory located within the medical simulation unit. The module memory and the unit memory may comprise the same content. Each piece of content within each memory may correspond to a particular RFID tag. Additionally, each piece of content within the unit memory may be synchronized to the movement of the mechanically movable element. Accordingly, the content within the unit memory may be associated with an RFID tag and a timestamp. A waveform generator may be used to synchronize the content to the movement of the mechanical element.

Upon detection of the RFID tag by the RFID reader, the unit processor may send a signal to the module processor. The signal may comprise the timestamp associated with the content corresponding to the detected RFID tag. The timestamp may relate to the movement of the mechanically moveable element. The timestamp may be used to synchronize the output to the movement of the mechanically moveable element. Upon receipt of the signal comprising the timestamp from the unit processor, the module processor may send content from the module memory to the transmitter. The module processor may also synchronize the content to the movement of the mechanically moveable element using the timestamp. For example, the processor may remove a first portion of the content in order to achieve the synchronization. Alternatively, and more preferably, the processor may signal the transmitter to output a discrete portion of the content. For example, if the content comprises a 5-second sound file, the processor may signal the transmitter to output the content starting at the third second of the sound file. This may result in the synchronization of the content with the movable elements.

In some embodiments, the output may be required for a longer duration than the remaining duration of the content file and, in some embodiments; the output may be required for a longer duration than the entire duration of the content file. In each of these embodiments, the content may be output any number of subsequent times. For example, the content may be ‘looped’. Each subsequent time that the content is output, the content may be output from the start of the file. This ensures synchronization remains.

In some embodiments, the output may be directly synchronized to the movement of the mechanically moveable element. Therefore, if the movement of the mechanically moveable element is varied, in use, the output may also be varied such that it remains synchronized.

As such, there is also provided a method for generating an output within a medical simulation system, the medical simulation system comprising: a medical simulation unit having an RFID tag, a unit processor and a unit memory; and a separate module comprising an RFID reader, a transmitter, a module processor, and a module memory, the method comprising: detecting the RFID tag using the RFID reader; identifying content within the module memory that is associated with the detected RFID tag; identifying content within the unit memory that corresponds to the content identified within the module memory, wherein the content identified in the unit memory is also associated with a timestamp; sending a signal from the unit processor to the module processor, wherein the signal comprises the timestamp; synchronizing the content identified within the module memory to the timestamp; and generating an output, via the transmitter, wherein the output comprises the synchronized content.

Alternatively, in some embodiments, content is sent from the unit memory directly to the transmitter. This content may be synchronized with a mechanically movable element. In such embodiments, the module does not comprise a module memory.

The timestamp may correspond to the movement of a mechanically moveable element within the medical simulation unit.

In some embodiments, the content within the, or each, memory is pre-set. However, in some embodiments, the system may further comprise a content generation unit configured to generate and/or modify the content.

The content generation unit may be located within the module. Alternatively, the content generation unit may be located within the medical simulation unit. The content generation unit may generate and/or modify the content in real time.

In some embodiments, the content generation unit may modify the content within the, or each, memory. Alternatively, or in addition, the content generation unit may modify the output. For example, the volume and/or tempo of the content and/or output may be modified.

The medical simulation unit may be a human mannequin or part thereof. For example, the medical simulation unit may comprise a torso, neck and/or shoulders. Alternatively, the medical simulation unit may be a non-human unit.

The medical simulation unit may comprise a plurality of RFID tags. Any number of RFID tags may be used. In some embodiments, the medical simulation unit comprises up to 5, 10, 15, 20, 30, 40, 50, 100, or 150 RFID tags. In other embodiments, the medical simulation unit comprises over 150 RFID tags.

Each RFID tag may have a different tag. Accordingly, each RFID tag may be associated with different content. Therefore, a plurality of RFID tags enables the output to vary depending on the location of the RFID reader on the medical simulation unit.

Using RFID technology and multiple RFID tags enables a single transmitter to output a plurality of different outputs. This prevents the needs for multiple transmitters, thus reducing the complexity of the system. In addition, a plurality of transmitters can lead to inaccurate and unrealistic overlapping of outputs. For example, some existing medical simulation units emit multiple outputs in the form of sounds. This requires multiple speakers to be located within the medical simulation unit that are configured to emit sounds. However, neighbouring transmitters can generate inaccurate and unrealistic overlapping of outputs. In addition and as previously discussed, the sounds being transmitted are often distorted by the material and structure of the simulation unit, thus further increasing the inaccuracy of the sound heard by the user. Using RFID technology avoids these issues as a single output is generated upon detection of each RFID tag. Each tag may cause the correct balance of sounds to be output as a single output.

In some embodiments, the system may comprise a plurality of modes. Within each mode, each RFID tag may correspond to different content. For example, a first mode may simulate a normal cardiac pattern. In this mode, an RFID tag may correspond to a sound file simulating a heartbeat at 60 bpm. In a second mode, the system may simulate a patient having a heart attack. In this mode, the same RFID tag may correspond to a sound file simulating a heartbeat at 110 bpm.

In some embodiments, at least one RFID tag is a Mifare Classic 1 k 25 mm tags. However, any suitable RFID tag may be used. The tags may be positioned in an offset grid pattern. The tags may be located within a main body of the medical simulation unit. The main body may be approximately 3 mm thick. The main body may be plastic. The main body may replicate the inner torso. The main body may comprise a skin. The tags may be located beneath the skin. The skin may be silicone. The silicone may be approximately 4 mm thick. In this embodiment, the RFID tags may be less than 20 mm apart. More preferably, the RFID tags may be less than 15 mm apart. Most preferably, the RFID tags may be less than 12 mm apart.

In some embodiments, the RFID tags may be spaced apart at approximately 10 mm intervals. However, any suitable spacing may be used. For example, the RFID tags may be spaced up to 1 mm, 3 mm, 5 mm, 8 mm, 10 mm, 15 mm, 20 mm, 25 mm or 30 mm apart. In some embodiments, the RFID tags may be spaced more than 30 mm apart.

There is also provided a medical simulation unit comprising a thrill simulation actuator configured to vibrate. The medical simulation unit having a thrill simulation actuator may be the previously disclosed medical simulation unit, thus also having any and/or all of the previously disclosed features. Alternatively, the medical simulation unit comprising a thrill simulation actuator may be a different medical simulation unit. In either case, the medical simulation unit may be in the form of a human mannequin, or a part thereof.

The vibration may simulate a thrill. The thrill simulation actuator may be configured to generate a vibration amplitude of between 0.3 G-1.5 G or, more preferably, between 0.5 G-1 G or, most preferably, between 0.6 G-0.8 G. In some embodiments, the thrill simulation actuator may be configured to generate a vibration amplitude of approximately 0.7 G.

The thrill simulation actuator may be located within the mechanically moveable element. For example, the thrill simulation actuator may be located within a plate, such as a chest plate.

The thrill simulation actuator may be a linear actuator. More specifically, the thrill simulation actuator may be a linear resonant actuator (LRA). In some embodiments, the thrill simulation actuator may be configured to vibrate at a frequency between 200-400 Hz. In some embodiments, the thrill simulation actuator may be configured to vibrate at a frequency of 225Hz-250 Hz or, more particularly, at approximately 237 Hz+8 Hz. The vibration frequency may be the resonant frequency of the actuator.

Each thrill simulation actuator may be less than 25 mm in diameter or, more preferable, less than 16 mm in diameter. In addition, each thrill simulation actuator may be less than 10 mm thick or, more preferably, less than 6 mm thick. In some embodiments, each thrill simulation actuator is approximately 8 mm in diameter and approximately 2.6 mm thick. The aforementioned sizing enables the thrill simulation actuators to replicate thrills generate by heart valves accurately. Each thrill simulation actuator may receive 1.2v. The linear resonant actuator (LRA) may use an AC voltage to drive a voice coil pressed against a moving mass connected to a spring. When the voice coil is driven at the resonant frequency of the spring, the entire actuator may vibrate with a perceptible force.

Alternatively, the medical simulation unit may comprise an eccentric rotating mass (ERM) vibration motor configured to vibrate. Again, the vibration may simulate a thrill. However, in some embodiments, an LRA is preferable as it may be smaller.

The eccentric rotating mass vibration motor may use a magnetic field from an electrical current to rotate a mass about a point. The rotating mass may be off-center from the point of rotation. Therefore, the eccentric rotating mass may produce an uneven centripetal force, which may cause the motor to vibrate. The current of the motor may run inside of the magnetic field such that the magnetic field applies a force to the rotating mass. Therefore, the vibrational intensity may be dependent on the DC current supplied.

The thrill simulation actuator may be connected to a control module. The control module may be configured to adjust the vibration generated by the thrill simulation actuator. For example, the vibration amplitude and/or frequency may be varied.

Alternatively, or in addition, the thrill simulation actuator may be connected to the unit processor. The unit processor may synchronise vibration of the thrill simulation actuator with mechanical movement in the medical simulation unit and/or the output.

The medical simulation unit may comprise a plurality of thrill simulation actuators. A plurality of thrill simulation actuators enables a closer to real life experience to be simulated. Each actuator may vibrate at a different vibration amplitude and/or frequency. Alternatively, each actuator may vibrate at the same vibration amplitude and/or frequency. In some embodiments, the medical simulation unit may comprise four thrill simulation actuators. Each thrill simulation actuator may be configured to replicate a thrill generate by one of the four heart valves.

When the medical simulation unit having at least one thrill simulation actuator is a part of the previously disclosed medical simulation system, the system may further comprise a processor configured to synchronize the output to the vibration of the thrill simulation actuator.

‘The memory’ may be the module memory. The processor may be located in the module. The processor may be the module processor. Accordingly, the module may comprise a single processor. The single processor may synchronize the output with the mechanical movement and/or vibration of the thrill simulation actuator.

Alternatively, the processor may be an additional processor located within the module. Therefore, the module may comprise a plurality of processors. Each processor may synchronize a different combination of parameters and/or components (i.e. the output, content, mechanical movement and/or vibration of the thrill simulation actuator).

Synchronizing the vibration of the thrill simulation actuator to the content within the memory enables any sounds, images, videos and/or data being output from the memory and/or processor to be output at the same time the actuator vibrates. This may provide a more realistic user experience.

The system may also comprise a processor configured to synchronize vibration of the thrill simulation actuator to the movement of a mechanically moveable element. The processor may be located within the medical simulation unit. The processor may be the unit processor. Accordingly, the medical simulation unit may comprise a single processor. The single processor may synchronize the output with the mechanical movement and/or vibration of the thrill simulation actuator.

Alternatively, the processor may be an additional processor located within the medical simulation unit. Therefore, the medical simulation unit may comprise a plurality of processors. Each processor may synchronize a different combination of parameters and/or components (i.e. the output, content, mechanical movement and/or vibration of the thrill simulation actuator).

Synchronizing the vibration of the actuator to the movement of a mechanically moveable element may further provide a more realistic user experience.

There is also provided a medical simulation unit comprising a main body and a plate, wherein the plate is operably connected to a plate driving actuator configured to rotate the plate about an axis. The medical simulation unit having a main body and a plate may be any of the previously disclosed medical simulation units, thus also having any and/or all of the previously disclosed features. Alternatively, the medical simulation unit having a main body and a plate may be a different medical simulation unit. In either case, the medical simulation unit may be in the form of a human mannequin, or a part thereof.

Therefore, the medical simulation unit of the present invention is configured to deliver a ‘closer to life’ training experience that incorporated the subtlety of human physiology into the medical simulation unit, thus allowing users to cement their understanding and muscle memory, giving them confidence when assessing real patients.

The plate may be connected to the main body via a rotatable joint. The rotatable joint may provide the axis of rotation. Therefore, the plate may rotate with respect to the main body. The plate may be the mechanically moveable element. The plate may replicate any moveable element on a human or non-human body. For example, the plate may be a chest plate. Alternatively, the plate may be an abdomen plate.

Rotation of the plate about an axis may be oscillatory rotation. The plate may rotate about a single axis of rotation. Alternatively, the plate may rotate about multiple axes of rotation. For example, the plate may rotate in any direction about a point. The point of rotation may be a ball and socket joint.

The main body may comprise a substantially planar back. The back of the medical simulation unit may simulate a human back. The rotatable joint may be attached to the back. The axis of rotation of the plate may be inclined by an angle, α, relative to the plane of the back. ‘Inclined’ means angled or sloped.

Therefore, the axis of rotation may intersect the plane of the back. In use, the plane of the back may be substantially vertical. Rotation of the plate about an axis that is inclined relative to the plane of the back generates movement of the plate in a plane that is parallel (i.e. vertical) and perpendicular (i.e. horizontal) relative to the back. Therefore, the plate, or at least a portion thereof, may move vertically (i.e. up) and horizontally (i.e. out) relative to the back when rotated. Providing a plate that moves up and out provides a more realistic breathing simulation.

The axis of rotation may be inclined by an angle, α, of approximately 45° relative to the plane of the back. However, in some embodiments, the axis of rotation is inclined by an angle, α, of up to 10°, 20°, 30°, 40°, 50°, 60°, or 70° relative to the plane of the back.

When the medical simulation unit is a human mannequin, or a part thereof, the commonly known sagittal plane, coronal plane, and transverse plane may be used as points of reference. The coronal plane (or frontal plane) divides the mannequin into dorsal and ventral (back and front, or posterior and anterior) portions. The transverse plane, also known as an axial plane or cross-section, divides the mannequin into cranial and caudal (head and tail) portions. The sagittal plane divides the body into sinister and dexter (left and right) portions.

The plane of the back may be substantially parallel to the Coronal plane. Therefore, the axis of rotation of the plate may be inclined relative to the Coronal plane. The main body may further comprise a base. The base may be substantially planar. The base may be configured to support the medical simulation unit in use. The base may be perpendicular to the back. Therefore, in use, the plane of the base may be substantially horizontal. For example, the plane of the base may be substantially parallel to the transverse plane. In some embodiments, the base may positioned through the location of a mannequin's waist, hips or thighs.

Alternatively, or in addition, the axis of rotation of the plate may be angled, by angle β, relative to the Transverse plane. The axis of rotation may be angled by an angle, β, of approximately 45° relative to the Transverse plane. However, in some embodiments, the axis of rotation is angled by an angle, β, of up to 10°, 20°, 30°, 40°, 50°, 60°, or 70° relative to the Transverse plane.

The plate may rotate up to 1°, 2°, 3°, 4°, 5°, 6°, 8°, 10°, or 15° about the axis of rotation. Most preferable, the plate may rotate up to 3.7° about the axis of rotation.

In some embodiments, the axis of rotation of the plate may comprise a first directional component and a second directional component. The first directional component may be inclined, by angle α, relative to the plane of the back. The second directional component may be inclined, by angle α, relative to the plane of the back and non-parallel to the first directional component.

In other words, when the medical simulation unit is a human mannequin, or part thereof, the second directional component of the axis of rotation may be inclined relative to the Coronal plane and angled relative to the Transverse plane.

Both the first and second directional components of the axis of rotation may be inclined by the same angle, α, relative to the plane of the back. In addition, the second directional component of the axis of rotation may be angled by an angle, β, of approximately 45° relative to the first directional component of the axis of rotation such that it is non-parallel thereto. However, in some embodiments, the second directional component of the axis of rotation may be angled by an angle, β, of up to 10°, 20°, 30°, 40°, 50°, 60°, or 70° relative to the first directional component of the axis of rotation.

In some embodiments, when the medical simulation unit is a human mannequin, or part thereof, the plate may hinge at the location of the inferior border of the clavicle. As such, the axis of rotation may be substantially parallel to the inferior border of the clavicle.

Each plate may comprise a proximal pole, located at the axis of rotation, and a distal pole, located on the point of plate that is far from the axis of rotation as possible. The distance between the proximal pole and distal pole may be up to 500 mm. More preferably, the distance may be up to 300 mm. For example, the distance may be 273 mm. Rotation of the plate about its axis may cause the distal pole to move up to 100 mm upwards (vertically) and up to 100 mm outwards (horizontally) relative to the plane of the back or, more preferably, up to 50 mm upwards (vertically) and up to 50 mm outwards (horizontally) relative to the plane of the back.

The plate driving actuator may be a linear actuator. In particular, the plate driving actuator may be a linear solenoid actuator. The plate driving actuator may be a linear actuator having a line of actuation transverse to the axis of rotation of the plate. The transverse line of actuation enables more rotational force to be generate about the point of rotation. The plate driving actuator may comprise a linear lead screw. The plate driving actuator may comprise a motor. The motor may be a stepper motor. The stepper motor may comprise up to 256 steps. In some embodiments, using 256 steps results in less than 40 dba at 1 m from the motor. In some embodiments, using at least 100 steps or, more preferably, at least 200 steps may results in less than 40 dba at 1 m from the motor. In fact, increasing the number steps reduces the noise generated by the motor. Therefore, in some embodiments, more than 256 steps may be used. The motor may drive the linear lead screw. When actuated, the linear lead screw may move the plate.

The plate driving actuator may comprises a shock resistor. The shock resistor may be positioned between the lead screw and the plate. The shock resistor may mitigate shock load.

Moreover, the system may comprise at least one damper between the motor of the plate driving actuator and the main body of the medical simulation unit. The damper may be located within a casing. The casing and the motor may form a motor assembly. The casing of the motor assembly may be a part of the main body of the medical simulation unit. Alternatively, the casing of the motor assembly may be a separate component. The motor of the plate driving actuator may be a stepper motor. The damper may be rubber. The damper may be in the form of a ring. The damper may be located between the motor and the casing of the motor assembly. The damper may limit the noise generated by the motor, in use. The system may comprises a plurality of dampers. For example, the system may comprise two motors, each having at least one damper between the motor and the casing and at least one damper between the screw thread of the actuator and the casing.

The plate driving actuator may be a linear actuator having a line of actuation substantially perpendicular to the axis of rotation of the plate. A substantially perpendicular line of actuation maximizes the rotation force that is generate by a given plate driving actuator about the axes of rotation. Again, the linear actuator may be a linear solenoid actuator.

The plate may comprise a lip portion configured to contact the main body and prevent further rotation of the plate when a predetermined maximum amount of rotation has occurred. The lip, therefore, prevents the plate from rotating more than a predetermined amount. This limits the size of gap that may form between the plate and the main unit, thus preventing larger objects and/or body parts, such as a finger, from becoming trapped and/or pinched between the plate and the main body.

The medical simulation unit may comprise a stretchable skin configured to enclose the main body and the plate. A discrete area of the skin may comprise reinforcement. The reinforcement may prevent gaps and/or soft spots forming between the plate and the main body. The reinforcement may be a non-woven interfacing material, such as Vilene. Reinforcement may start below angle of Louis as this may be palpated during examination. The main body may comprise a sternum. The sternum may be position between two adjacent plates. The two adjacent plates may be chest plates. Each chest plate may comprise a lip. Reinforcement may not extend beyond an outer edge of the sternum as this area may be palpated during examination.

The medical simulation unit may comprise a switch. The switch may be configured to allow movement of the plate driving actuator only when the skin is fitted over the main body the plate. The switch may control the power supplied to the plate driving actuator. The switch may be a micro-switch. If the skin is not fitted, or is not fitted correctly, the switch may be configured to prevent movement of the plate driving actuator, thus preventing rotation of the plate. This prevents a user's finger (or other body part or object) from being trapped between/under the moving plate.

The medical simulation unit may comprise a spring. The spring may be configured to apply pressure to a component fixed within the main body. Alternatively, or in addition, the medical simulation unit may comprise a damper. The damper may be located between the plate driving actuator and the main body. In some embodiments, the medical simulation unit comprises at least one of a spring and a damper.

The fixed component may be the plate driving actuator. More specifically, the fixed component may be the motor assembly or, more specifically, the motor of the plate driving actuator. A spring within the main body may be used to reduce, or prevent, the vibration of fixed components. In some embodiments, this may enable the medical simulation unit to produce less than 40dba of sound from 1 m.

There may be plurality of dampers. The medical simulation unit may comprise at least one damper between the motor of the actuator and the main body of the medical simulation unit.

In some embodiments, there is also provided a processor configured to synchronize the output to the rotation of the plate. The processor may be located in the medical simulation unit. Alternatively, the processor may be located in the module. The processor may be the module processor. Accordingly, the module may comprise a single processor. The single processor may synchronize the output with the movement of the mechanically moveable element, vibration of the thrill simulation actuator and/or movement of the plate.

Alternatively, the processor may be an additional processor located within the module. Therefore, the module may comprise a plurality of processors. Each processor may synchronize a different combination of parameters and/or components (i.e. the output, content, mechanical movement and/or vibration of the thrill simulation actuator).

In some embodiments, the speed, tempo, and/or range of rotation of the plate about the axis is pre-set and fixed. Alternatively, in some embodiments, the plate driving actuator may be operably connected to a control unit configured to control the movement of the actuator. The control unit may be located on an outside surface of the medical simulation unit. The control unit may be accessible when the medical simulation unit is in use. The control unit may be a variable dial. Alternatively, the control unit may be a processor. The processor may be located within the medical simulation unit. Accordingly, the processor may be the unit processor. Alternatively, the processor may be an additional processor.

Controlling the movement of the plate driving actuator may control the rotation of the plate about its axis. The control unit may modify the speed, tempo and/or range of rotation of the plate about the axis, in use, by adjusting the speed, tempo and/or range of moment of the plate driving actuator. This may be used to simulate scenarios such as slowing and/or shallowing breathing patterns more realistically.

In the context of this application, the speed of rotation defines how long it takes the plate to complete one full oscillation. Conversely, the tempo of rotation defines how many oscillations are completed within a given time period. For example, a breathing pattern may have a fast speed but slow tempo if there are prolonged pauses between each cycle.

In some embodiments, the plate driving actuator, thus the plate, may complete up to one full oscillation every 0.5 seconds. Accordingly, the tempo of rotation of the plate may be up to 120 breaths per minute (BPM). Alternatively, or in addition, the plate driving actuator, thus the plate, may complete up to one full oscillation every 0.75, 1, 1.5, or 2 seconds. Accordingly, the tempo of rotation of the plate may be up to 90, 60, 45, or 30 breaths per minute (BPM).

The medical simulation unit may comprise a plurality of plates. Each plate may be connected to a corresponding plate driving actuator configured to rotate the plate about an independent axis. In some embodiments, there are two plates. Each plate may be configured as previously described. Each independent axis of rotation may be configured as previously described. However, the independent axes of rotation may be non-parallel to each other. In other words, the axes of rotation of the plates may converge. For example, each axis may be inclined relative to a plane parallel to the back of the medical simulation unit by the same amount, α, but in the opposite direction, α, −α. The angle α, −α, may generate the first directional component of the axis of rotation. Similarly, each independent axis of rotation may comprise a second directional component that is angled by angle, β, relative to the first direction component, but in the opposite direction, β, −β.

Each plate may rotate about its corresponding axis independently. For example, the speed, tempo and/or range of rotation of each plate may be controlled independently. This enables a symmetrical and/or asymmetrical plate movement at variable rates and/or patterns.

The invention will now be further and more particularly described, by way of example only, with reference to the accompanying drawings

### FIGURES

FIG. 1 shows a medical simulation unit having at least one RFID tag;

FIG. 2 shows a module comprising an RFID reader, a transmitter and a memory;

FIG. 3 shows a medical simulation unit having at least one RFID tag, a mechanically moveable element and a processor configured to synchronize the output to the mechanically moveable element;

FIG. 4A shows a medical simulation unit comprising a thrill simulation actuator;

FIG. 4B is an exploded view of the thrill simulation actuator shown in FIG. 4A;

FIG. 5A shows a medical simulation unit comprising a main body and a moveable plate;

FIG. 5B shows a section through the medical simulation unit of FIG. 5A;

FIG. 5C shows the axis of rotation of the plate of FIGS. 5A and 5B relative to the plane of the back of the medical simulation unit;

FIG. 5D shows the axis of rotation shown in FIG. 5C having a first and second directional component;

FIG. 5E shows a lip portion of the mechanically moveable plate;

FIG. 6 shows a medical simulation system; and

FIG. 7 shows a system diagram for the medical simulation unit shown in FIG. 6.

### DETAILED DESCRIPTION

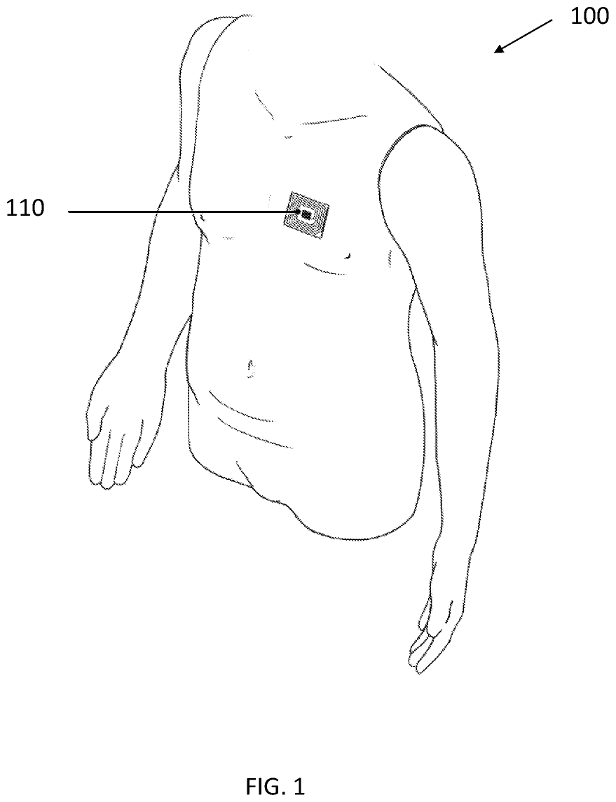

FIG. 1 shows a medical simulation unit 100 for use within a medical simulation system 10. The medical simulation unit 100 comprises an RFID tag 110. The figure only shows one RFID tag 110 for simplicity. However, any number and/or type of RFID tags 110 may be used.

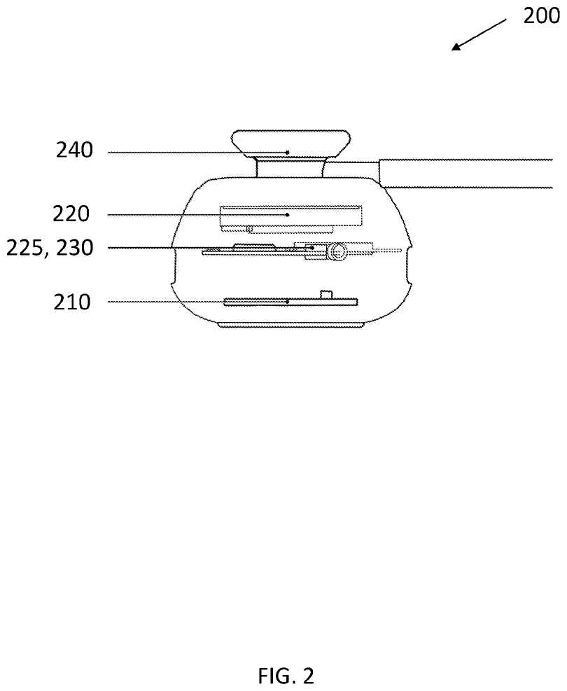

FIG. 2 shows a module 200 for use within a medical simulation system 10. The module 200 comprises an RFID reader 210, a transmitter 220, a processor 230 and a memory 225. The reader 210 comprises an antenna. The module 200 is configured to output content from the memory 225 via the transmitter 220 when the RFID reader 210 detects an RFID tag 110. The module 200 is configured to connect to a device 240 for receiving the output. In FIG. 2, the device 240 is a stethoscope.

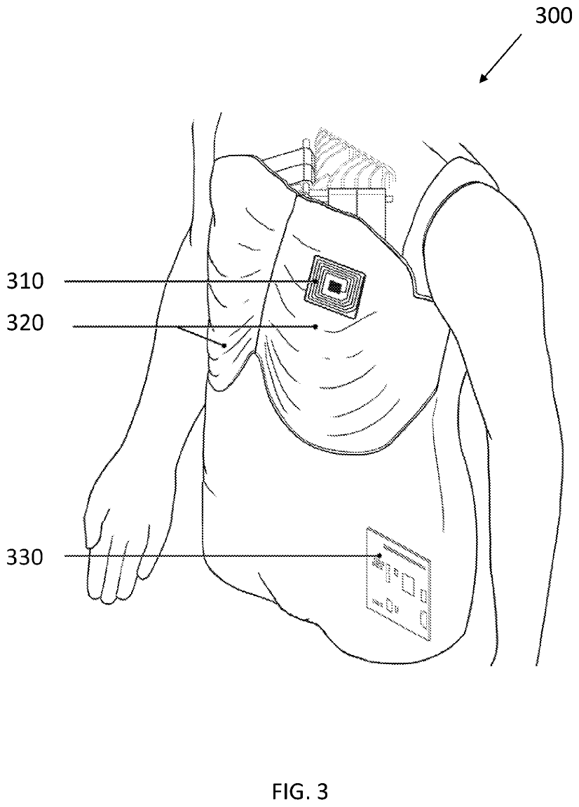

FIG. 3 shows a medical simulation unit 300 for use within a medical simulation system 10. The medical simulation unit 300 comprises an RFID tag 110, 310, a mechanically moveable element 320 and a processor 330. The processor 330 is located inside the medical simulation unit 10. The processor 330 is configured to synchronize the output of the module 200 to the mechanically moveable element 320. The mechanically moveable element 320 is a moveable plate 320. In particular, in FIG. 3 the mechanically moveable element 320 is a chest plate, however, the mechanically moveable element 320 may take any other suitable form. For example, the mechanically moveable element 320 may simulate any biomechanical movement. In some embodiments, the mechanically moveable element 320 is a lung plate or an abdomen plate.

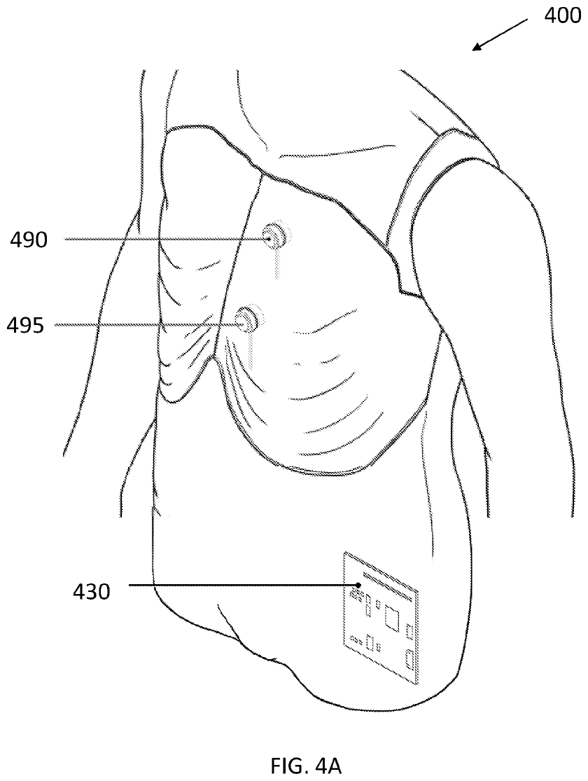

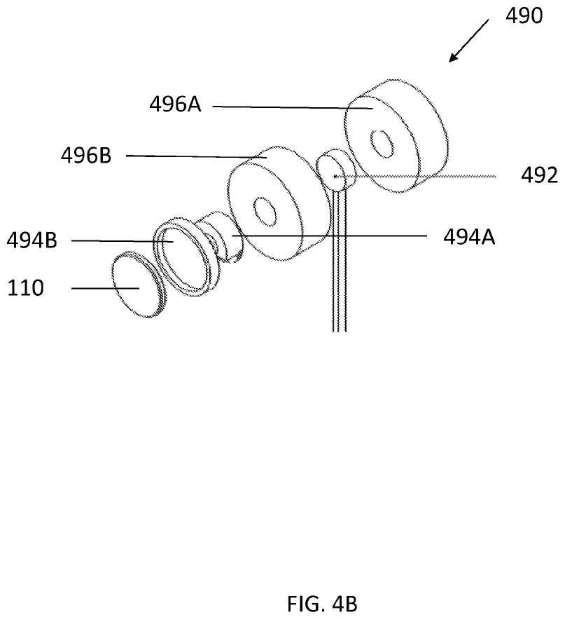

FIG. 4A shows a medical simulation unit 400 comprising a thrill simulation actuator 490. In fact, FIG. 4A shows a first thrill simulation actuator 490 and a second thrill simulation actuator 495. However, any number of thrill simulation actuators may be present.

The medical simulation unit 400 further comprising a processor 430. The processor 430 is located inside the medical simulation unit 400. The processor 430 is configured to synchronize vibration of the thrill simulation actuator 490 to the output. In some embodiments, the medical simulation unit 400 comprises a single processor 330, 430. Alternatively, in other embodiments, the medical simulation unit 400 comprises a first processor 330 and a second processor 430.

The processor(s) 330, 430 may also be configured to synchronize vibration of the thrill simulation actuator 490 to the movement of a mechanically moveable element 320.

FIG. 4B is an exploded view of the thrill simulation actuator 490 shown in FIG. 4A. More specifically, the thrill simulation actuator 490 comprises a linear resonant actuator (LRA) 492. The LRA 492 is located within a casing 494. The casing comprises a first portion 494A configured to hold the LRA 492. In some embodiments, as shown in FIG. 4B, the casing also comprises a second portion 494B configured to hold the RFID tag 110. The first portion of the casing 494A containing the LRA 492 is then enclosed within a foam padding 496 that is shown split into two halves 496A, 496B. The foam padding is configured to dampen the vibration of the LRA. As shown in FIG. 4B, the linear resonant actuator 492 is positioned in line with the RFID tag 110. This enables the medical simulation unit to simulate a thrill more accurately.

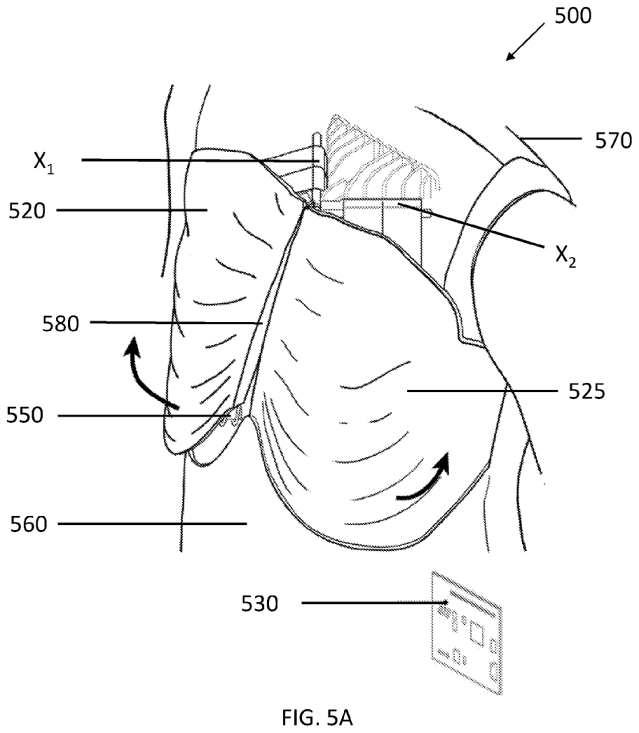

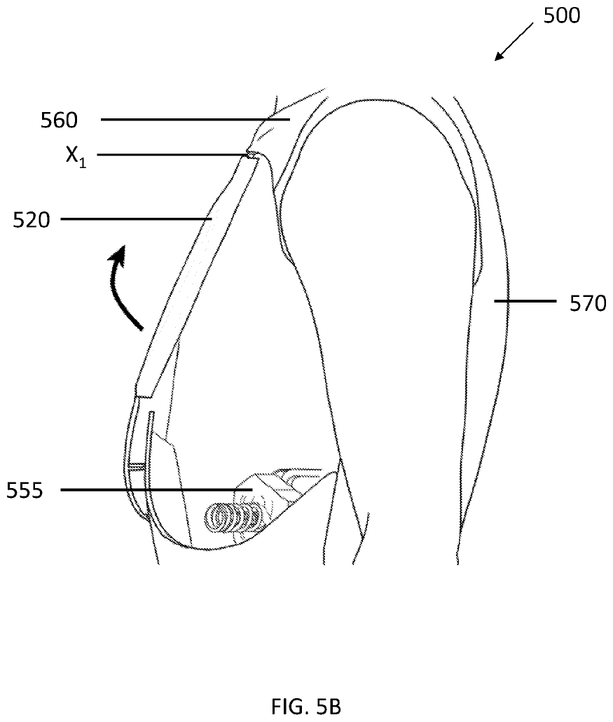

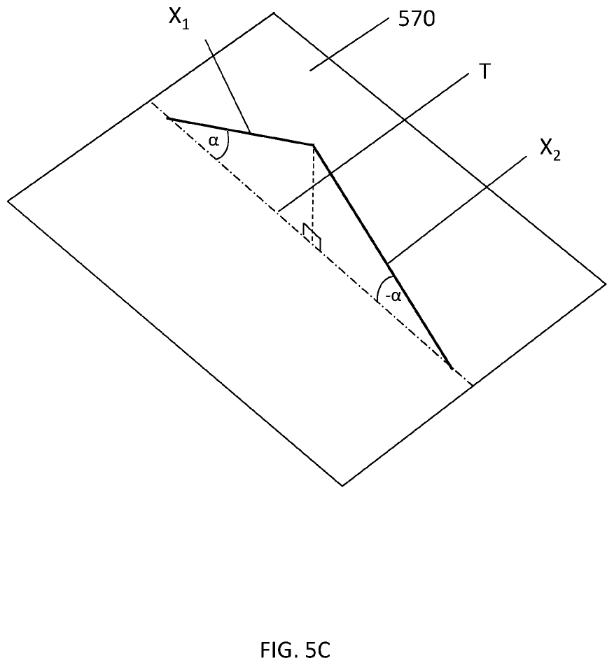

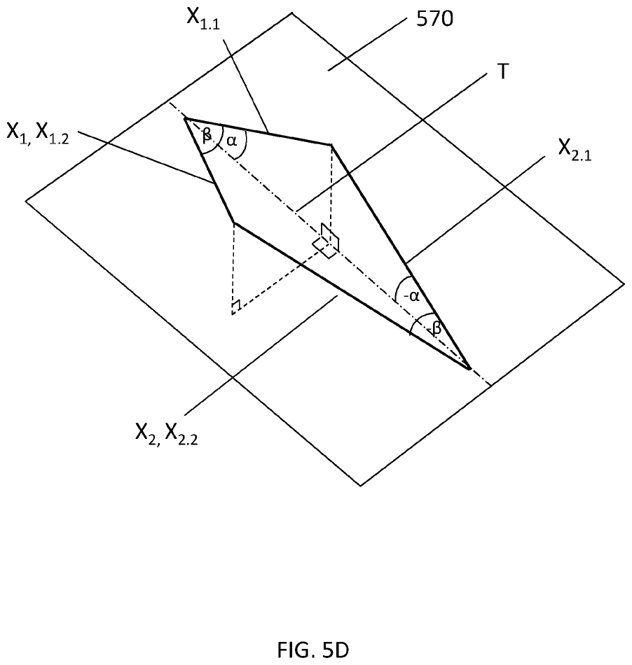

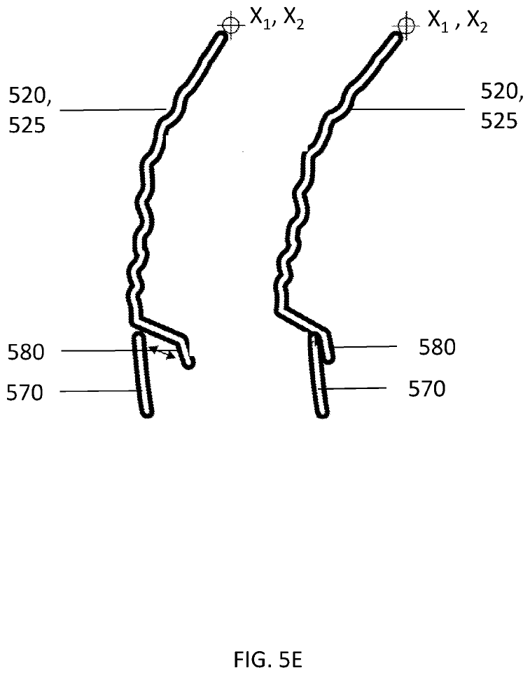

FIG. 5A shows a medical simulation unit 500 comprising a main body 560 and a moveable plate 520. In some embodiments, the plate 520 is the mechanically moveable element 320. In fact, FIG. 5A shows a first plate 520 and a second plate 525. Each plate 520, 525 may be a mechanically moveable element 320. However, any number of plates may be present. For example, in some embodiments, each plate 520, 525 is split into a plurality of separate plates, thus providing additional planes of movement that result in a more realistic medical simulation unit. FIG. 5A also shows a plate driving actuator 550 configured to rotate the plate 520 about the axis X₁.

FIG. 5B shows a section through the medical simulation unit 500 of FIG. 5A. As shown in FIG. 5B, the medical simulation unit 500 comprises a main body 560, a moveable plate 520, and a plate driving actuator 555. The plate driving actuator 555 is configured to rotate the plate 525 about an axis X₂. However, is FIG. 5B, plate 525 has been omitted. Plate 520 is shown in FIG. 5B. Plate 520 is moveable by a corresponding plate driving actuator 550, which is not visible in FIG. 5B as it is located behind the plate driving actuator 555. As such, when more than one plate 520, 525 is present, as shown in FIG. 5A, each plate 520, 525 is connected to a corresponding plate driving actuator 550, 555 configured to rotate the plate 520, 525 about an independent axis X₁, X₂.

The plate driving actuator 550, 555 is a linear actuator. More particularly, the plate driving actuator 550, 555 is a linear resonant actuator (LRA). However, in some embodiment, the plate driving actuator 550, 555 is a linear stepper motor or a linear solenoid actuator. The plate driving actuator 550, 555 has a line of actuation transverse to the axis of rotation, X₁, X₂ of the plate 520, 525. In fact, in some embodiments, the plate driving actuator 550, 555 has a line of actuation substantially perpendicular to the axis of rotation, X₁, X₂ of the plate 520, 525.

The medical simulation unit 500 may further comprise a processor 530. The processor 530 is located inside the medical simulation unit 500. The processor 530 is configured to synchronize the output of the module 200 to the rotation of the plate 520, 525 about its axis X₁, X₂. The processor 530 may be the processor 330 shown in FIG. 3 and/or the processor 430 shown in FIG. 4. Alternatively, the processor 530 may be a different processor.

Moreover, in some embodiments, the plate driving actuator 550, 555 is operably connected to a control unit (not shown) configured to control the movement of the actuator 550, 555. The control unit may be located on the outside of the medical simulation unit such that it is accessible by a user. The main body 560 comprises a substantially planar back 570. The axis of rotation X₁, X₂ of the plate 520, 525 is inclined relative to the plane of the back 570 by angle α, as shown in FIG. 5C. In some embodiments, the axis of rotation X₁, X₂ of the plate 520, 525 is also angled relative to the Transverse plane, T, by angle β, as shown in FIG. 5D. Both α and β are approximately 45°. However, any angle of α and β may be used.

FIG. 5D has also been provided, which shows the axis of rotation X₁, X₂ having a first and second directional component. In particular, the axis of rotation X₁, X₂ comprise a first directional component X_{1.1}, X_{2.1} and a second directional component X_{1.2}, X_{2.2}. The first directional component X_{1.1}, X_{2.1} of the axis of rotation X₁, X₂ is inclined relative to the plane of the back by angle α. The second directional component X_{1.2}, X_{2.2} of the axis of rotation X₁, X₂ is inclined relative to the plane of the back by angle α and non-parallel to the first directional component. The angle between the first X_{1.1}, X_{2.1} and second X_{1.2}, X_{2.2} directional component of the axis of rotation X₁, X₂ is β.

As shown in FIGS. 5A, 5C and 5D, the first and second axes of rotation X₁, X₂ are non-parallel. In other words, the first and second axes of rotation X₁, X₂ converge. As such, each axis is inclined relative to a plane parallel to the back of the medical simulation unit by the same amount, α, but in the opposite direction, α, −α. The angle α, −α, generates a first directional component of the axis of rotation. Similarly, if present, a second directional component of each axis of rotation is angled by angle, β, relative to the first direction component, but in the opposite direction, β, −β.

Each plate 520, 525 also comprises a lip portion 580 configured to contact the main body 570 and prevent further rotation of the plate 520, 525 when a predetermined maximum amount of rotation has occurred, as shown in FIG. 5E.

In addition, the medical simulation unit comprises a stretchable skin (not shown in the accompanying drawings) configured to enclose the main body 570 and the plate 520, 525. A discrete area of the skin comprises reinforcement.

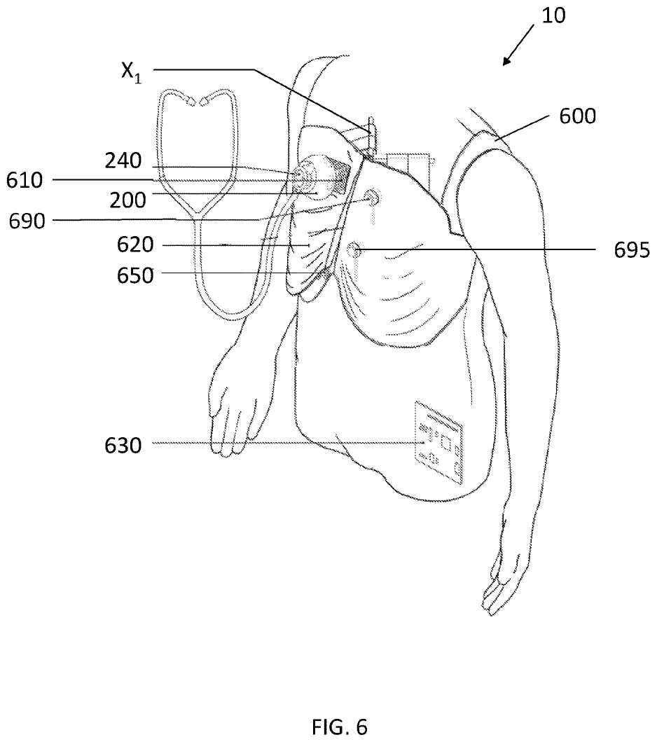

FIG. 6 shows a medical simulation system 10. The medical simulation system 10 comprises a medical simulation unit 600 and a separate module 200. The medical simulation unit 600 comprises an RFID tag 610. The figure only shows one RDIF tag 610 for simplicity, however, any number of RFID tags 610 may be used. The separate module comprising an RFID reader 210, a transmitter 220 and a memory 225 for storing content. The module 200 is configured to output content from the memory 225 via the transmitter 220 when the RFID reader 210 detects the RFID tag 610. The module 200 is configured to connect to a device 240 for receiving the output. In FIG. 6, the device 240 is a stethoscope.

The medical simulation unit 600 further comprises a mechanically moveable element 620 and a processor 630. The processor 630 is located inside the medical simulation unit 600. The processor 630 is configured to synchronize the output of the module 200 to the mechanically moveable element 620. The mechanically moveable element 620 is a moveable plate 620. In particular, in the presented figures, the mechanically moveable element 620 is a chest plate. However, the mechanically moveable element 620 may take any other suitable form. For example, the mechanically moveable element 620 may be a lung plate or an abdomen plate. The plate driving actuator 650 moves the mechanically moveable elements. The plate driving actuator 650 is configured to rotate the plate 620 about an axis X₁.

The medical simulation unit 600 further comprises a thrill simulation actuator 690. In fact, FIG. 6 shows a first thrill simulation actuator 690 and a second thrill simulation actuator 695. However, any number of thrill simulation actuators may be present. The thrill simulation actuator 690, 695 comprises a linear resonant actuator (LRA).

The processor 630 is further configured to synchronize vibration of the thrill simulation actuator 690, 695 to the output. In some embodiments, the medical simulation unit 600 comprises a single processor 330, 430, 530, 630. Alternatively, in other embodiments, the medical simulation unit 400 comprises a plurality of processors 330, 430, 530, 630. The processor(s) 330, 430, 530, 630 may also be configured to synchronize vibration of the thrill simulation actuator 490 to the movement of a mechanically moveable element 320.

Medical simulation unit 600 is shown in FIG. 6; however, any of the previously disclosed medical simulation units 100, 300, 400, 500 may be used.

In each of the embodiments shown in the accompanying figures, the medical simulation unit 100, 300, 400, 500, 600 is a human mannequin or part thereof. However, in other embodiments, not illustrated in the accompanying drawings, the medical simulation unit may be a non-human form.

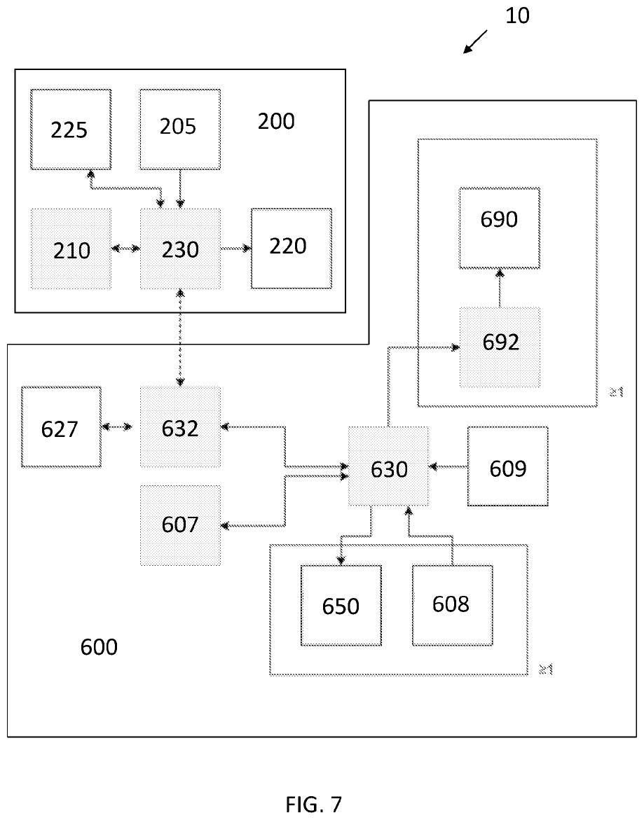

FIG. 7 shows the electronic system used within the medical simulation system shown in FIG. 6. The system comprises a module 200 having a printed circuit board assembly (PCBA) comprising the module processor 230. The module processor 230 is connected to an RFID reader 210, a transmitter 220, a module memory 225, and a battery 205. The battery 205 is configured to provide power the module 200. The module processor 230 is also in electronic communication with a webserver and audio module (WAM) PCBA 632 located within the medical simulation unit 600. The WAM PCBA is connected to a memory 627. The memory 627 comprises all the content stored within the module memory 225. The memory 627 may also comprises additional content and or files.

The medical simulation unit 600 comprises a power switch 607 and a power source 609. The power source 609 may be a battery. Alternatively, or in addition, the power source may be a mains supply. The switch 607 is configured to control the power supply to the medical simulation unit 600.

The WAM PCBA is connected to the unit processor 630. The unit processor 630 is connected to a Thrill simulation PCBA 692 configured to control the thrill simulation actuator 690. Although, any number of Thrill simulation PCBAs and thrill simulation actuators may be present. The unit processor 630 is also connected to a plate driving actuator 650. The plate driving actuator 650 is configured to rotate the plate 620 about its axis X₁. Although, any number of plate driving actuators may be present. An end-switch switch 608 is also connected to the unit processor 630. The end switch 608 is configured to allow movement of the plate driving actuator 650 only when a skin is fitted over the main body and the plate 620 of the medical simulation unit 600.

Various further aspects and embodiments of the present invention will be apparent to those skilled in the art in view of the present disclosure. “and/or” where used herein is to be taken as specific disclosure of each of the two specified features or components with or without the other. For example, “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments that are described. It will further be appreciated by those skilled in the art that although the invention has been described by way of example with reference to several embodiments, it is not limited to the disclosed embodiments and that alternative embodiments could be constructed without departing from the scope of the invention as defined in the appended claims.

1. A medical simulation system comprising:
a medical simulation unit having a mechanically moveable element and an RFID tag; and
a separate module comprising an RFID reader, a transmitter and a memory for storing content,
wherein the module is configured to output content from the memory via the transmitter when the RFID reader detects the RFID tag, and
wherein the medical simulation system further comprises a processor configured to synchronize the output to the movement of the mechanically moveable element.

2. The system according to claim 1, wherein the module is configured to connect to a device for receiving the output.

3-4. (canceled)

5. The system according to claim 1, further comprising a content generation unit configured to generate and/or modify the content.

6. The system according to claim 1, wherein the medical simulation unit is a human mannequin or part thereof.

7. The system according to claim 1, wherein the medical simulation unit comprises a plurality of RFID tags.

8. The system according to claim 1, wherein the medical simulation unit further comprises a thrill simulation actuator configured to vibrate.

9. The system according to claim 8, wherein the thrill simulation actuator is a linear actuator.

10. (canceled)

11. The system according to claim 8, wherein the system comprises a processor configured to synchronize vibration of the thrill simulation actuator to the movement of a mechanically moveable element.

12. (canceled)

13. The system according to claim 1, wherein the medical simulation unit comprises a main body and a plate, wherein the plate is operably connected to a plate driving actuator configured to rotate the plate about an axis.

14. The system according to claim 13, wherein the main body comprises a substantially planar back and wherein the axis of rotation of the plate is inclined by an angle, α, relative to the plane of the back.

15. The system according to claim 14, wherein the axis of rotation of the plate comprises a first directional component and a second directional component, wherein the first directional component is inclined, by angle α, relative to the plane of the back and the second directional component is inclined, by angle α, relative to the plane of the back and non-parallel to the first directional component.

16. The system according to claim 13, wherein the plate driving actuator is a linear actuator having a line of actuation transverse to the axis of rotation of the plate.

17. The system according to claim 13, wherein the plate driving actuator is a linear actuator having a line of actuation substantially perpendicular to the axis of rotation of the plate.

18. The system according to claim 13, wherein the plate comprises a lip portion configured to contact the main body and prevent further rotation of the plate when a predetermined maximum amount of rotation has occurred.

19. The system according to claim 13, further comprising a stretchable skin configured to enclose the main body and the plate, wherein a discrete area of the skin comprises reinforcement.

20. The system according to claim 19, further comprising a switch configured to allow movement of the plate driving actuator only when the skin is fitted over the main body the plate.

21. The system according to claim 13, further comprising at least one of:
a spring configured to apply pressure to a component fixed within the main body; and
a damper located between the plate driving actuator and the main body.

22. The system according to claim 13, further comprising a processor configured to synchronize the output to the rotation of the plate.

23. The system according to claim 13, wherein the plate driving actuator is operably connected to a control unit configured to control the movement of the actuator.

24. The system according to claim 13, wherein the medical simulation unit comprises a plurality of plates, and wherein each plate is connected to a corresponding plate driving actuator configured to rotate the plate about an independent axis.

25. (canceled)
